(19) United States
(12) Patent Application Publication
(10) Pub. No.: US 2008/0030290 A1
(43) Pub. Date: Feb. 7, 2008

(54) Magnetic stylus and visual display

(76) Inventor: Robert John Norman, Sandy, UT (US)

Correspondence Address: HOLME ROBERTS & OWEN, LLP, 299 SOUTH MAIN, SUITE 1800, SALT LAKE CITY, UT, 84111, US

(21) Appl. No.: 11/499,333

(22) Filed: Aug. 4, 2006

(51) Int. Cl. H01F 3/00

(52) U.S. Cl. 335/296

(57) ABSTRACT

A stylus arranges permeable flakes in a dispersion medium. The stylus includes a magnet having at least one side. A sleeve is disposed around the side of the magnet. The sleeve is made of a ferromagnetic material and arranged to modify the magnetic flux of the magnet. At least a portion of the magnet extends out from the sleeve to interact with the permeable flakes.

### BACKGROUND OF THE INVENTION

1. The Field of the Invention

The present invention relates to visual displays and, more particularly, to a magnetic stylus combination with a visual display having permeable flakes disposed in a medium wherein the stylus uses magnetic force to orient flakes to form a visually perceptible image on a surface of the visual display.

2. State of the Art

It is known that one may form a visually perceptible image on a display surface by applying a magnetic field provided by a stylus with a magnet at or proximate a tip positioned proximate the display surface. Magnetic particles or magnetically permeable particles proximate the display surface and on the side of the display surface opposite to the stylus may be dawn toward the display surface or aligned to create the image. In some arrangements, particles are dispersed within a viscous liquid within a volume that has at least one translucent surface as the display surface through which the user observes the created image. The particles are magnetic or are permeable (may be induced by another magnetic field to exhibit magnetic characteristics) and migrate to and in the magnetic field provided by the stylus and accumulate and align with the magnetic field or flux along the locus of the magnetic lines of force of the magnetic field. In such arrangement, the aligned particles change the translucency of the viscous liquid by allowing light to pass and in turn create an image as the stylus is moved over the display surface. Alternately, magnetic particles will be drawn toward the stylus and accumulate at or near the surface to form a desired image.

U.S. Pat. No. 4,643,684 to Murata et al. discloses the use of a magnetic display panel which includes a dispersing medium having a yield value of 5 dyne/cm² or more, the medium comprising an inorganic thickener, fine magnetic particles, and a colorant. The Murata patent discloses the use of a multi-cell structure which confines the dispersing medium within each cell, the structure assisting in limiting the migration of the medium and the magnetic particles from one cell into the next during the application of a magnetic field to the particles.

In U.S. Pat. No. 5,018,979 to Gilano et al. and U.S. Pat. No. 5,112,229 to Gilano et al., a magnetic display is provided in which an enclosure which contains permeable particles or flakes held within a dispersion medium which holds the permeable flakes in suspension. This arrangement allows alignment of the flakes along the flux lines of a magnetic field provided by a movable stylus.

The GHOST WRITER™ sold by Ohio Art of Bryan, Ohio produced a visual image using a stylus having a magnet with magnetically permeable particles suspended in the medium. The ETCH-A-SKETCH® imaging device also sold by Ohio Art involved use of a stylus and magnetic particles positioned proximate a display surface in which the stylus moved the particles to create the image.

To improve the contrast of an image, U.S. Pat. No. 5,295,837 discloses a visual display having a light source used as a backlight to transmit light through a dispersion medium. The transmitted light purports to improve the visual distinction between the areas of aligned flakes and randomly-oriented flakes. In addition, a rear surface may be colored to enhance the contrast between the flakes and the colored background. Furthermore, spacers have been added to separate the surfaces between the medium containing the flakes to provide a more uniform background.

In practice, the ETCH-A-SKETCH® product offered high resolution. That is, a stylus was operated to etch a line that was visible on the face of a translucent screen. But at the same time, once a line was created, it could not be erased easily. Rather the user would need to wait until the created line deteriorated over a period of time, e.g., several hours. Imaging systems involving a stylus with a translucent or transparent container holding a medium (e.g., viscous fluid) in which magnetic flakes are suspended could be promptly erased, in some cases by rubbing or in others by using an erasing magnet. However, such systems have suffered from poor resolution. That is, the lines made using a hand operated stylus were wide and fuzzy. Thus improved systems providing better resolution are desired.

### BRIEF SUMMARY OF THE INVENTION

A stylus arranges magnetic or magnetically permeable flakes in a dispersion medium. The stylus includes a magnet having at least one side. A sleeve is disposed around the exterior of the magnet. The sleeve is made of a ferromagnetic material and arranged to modify or direct the magnetic field of the magnet. At least a portion of the magnet extends out from the sleeve to interact with the permeable magnetically permeable flakes.

These and other features of the present invention will become more fully apparent from the following description, or may be learned by the practice of the invention as set forth hereinafter.

### BRIEF DESCRIPTION OF THE DRAWINGS

The following listed drawings depict only typical and preferred embodiments of the invention and are identified as follows:

FIG. 1 is a depicts an imaging system of the prior art having permeable flakes dispersed within a dispersion medium with a magnet oriented in a first position to not influence the flakes;

FIG. 2 is a perspective view of the imaging system of FIG. 1 in a second position having its magnetic field depicted by magnetic flux lines extending into the dispersion medium and influencing the flakes;

FIG. 3 is a side view of a magnet for use with the present invention illustrating its magnetic field by magnetic flux lines;

FIG. 4 is a cross-sectional view of a stylus tip of the present invention having a magnet and a sheath thereabout;

FIG. 5 is a cross-sectional view of an alternate form of the stylus tip of the present invention; and

FIG. 6 is a perspective side view of a stylus in accordance with the present invention.

### DETAILED DESCRIPTION OF THE EXEMPLARY EMBODIMENTS

Reference will now be made in detail to the exemplary embodiments of the present invention, examples of which are illustrated in the accompanying drawings. The various exemplary embodiments provide a stylus for a visual display.

In the visual display, an image is formed by aligning flakes that can be either magnetic or magnetically permeable. The flakes are contained and mixed within a dispersion medium. Upon presentation of a magnetic field, the flakes orient along the flux lines of the magnetic field. Alignment of the flakes changes the translucency so that light may pass through the medium in the vicinity of the aligned flakes. Before alignment, the flakes are dispersed in the medium; and the flakes in effect scatter or block the light that is directed through the dispersion medium.

When a magnetic field is applied from a permanent magnet, for instance, such as one formed from a nickel alloy composition, an amorphous magnet of iron nickel boron composition, or other suitable magnetic material, magnetic particles or permeable, particles tend to be attracted to the magnetic field of the magnet and accumulate within the magnetic field. A magnetic field is sometimes depicted by illustrating a plurality of lines like lines 24 and 26 in FIG. 1. That is, the lines attempt to show a three dimensional magnetic field but in two dimensions. Thus one has to envision the field surrounding the magnet in three dimensions.

By dispersing the permeable particles in a viscous liquid, the viscosity of the liquid slows down the magnetic alignment of the particles but also holds the magnetic particles in the magnetically induced alignment so the image remains stable after formation. Of course the viscosity of the liquid containing the permeable or magnetic flakes must also be sufficiently low that permeable or magnetic particles may move through the liquid toward a magnetic field and or to be in alignment with he lines of flux of the magnetic field.

It has been observed that the overall geometry of each of these permeable particles exhibiting this attraction phenomenon which travel through the viscous liquid to the magnetic field have a geometry which is generally spherical. In fact, it has been observed that as these permeable particles become more spherical in shape, the travel of the particles through the viscous liquid to the applied magnetic field occurs with greater frequency and becomes more apparent. However, as the configuration of the permeable particles becomes less spherical and more flattened or flake-like, these particles tend to align along the flux lines of the magnetic field and not travel through the viscous liquid to the locus of the magnetic field, remaining relatively stationary. Thus, image in the visual display formed is dependent on the geometry of the permeable particles as well as on the nature of the magnet presented for forming the image.

One measure of the geometry of a particle is the ratio of a particle's length to width to height. For convenience, this ratio is defined as the aspect ratio of the particle. Determination of the aspect ratio of a magnetic particle provides a measurement in absolute terms of the geometry of a magnetic particle. Calculation of the aspect ratio thus provides a standard for selecting metallic particles for use in the visual display which have the desired alignment characteristics along the flux lines of the applied magnetic field.

For a spherical particle, the aspect ratio is 1:1:1, or unity. Particles with an aspect ratio approximating unity generally do not align along the flux lines of the magnetic field when contained in a viscous liquid, but exhibit the attraction and movement phenomenon as described above, traveling through the liquid and accumulating at the locus of the magnetic field.

In one example, commercially available metal particles such as Inco Nickel Powder Type 123 are used that have a particle size approximating four microns with the particles having a dendritic geometry. Due to the small, irregular size of the particles, however, it is difficult to determine which is the longest axis for determination of an aspect ratio of the particles. Nonetheless, these particular particles behave like spherical particles having an aspect ratio of unity when they are exposed to a magnetic field. In like manner, spherical nickel particles, such as those commercially available from Novamet, Inc., (Novamet 4SP), an eight-micron diameter sphere with an aspect ratio of unity, will travel through a dispersion medium when attracted to a magnetic field and not align along the flux lines of the magnetic field. (Commercially available ferrous powders, such as 325 mesh and 100 mesh by Hoeganaes, also exhibit the attraction phenomenon.)

When the aspect ratio of the particles varies from that of unity, the particles tend to line up with their longest axis in the direction of the flux lines of an applied magnetic field. This alignment provides a change in the light transmission through the visual display.

Permeable particles, including metallic and non-metallic particles having an aspect ratio greater than unity which exhibit the alignment phenomenon along the flux lines of an applied magnetic field, are hereinafter referred to as permeable flakes. Permeable flakes are thus defined as metallic particles exhibiting the alignment characteristics which provide the change in the light transmission characteristics of the dispersion medium. For instance, flakes that are 15 microns in length and width and 1 micron in height have an aspect ratio of 15:15:1. With an aspect ratio of 15:15:1, these flakes exhibit the alignment phenomenon along the flux lines of a magnetic field. Also, because of the induced magnetic field properties of the flakes after exposure to the magnetic field, the flakes exhibit both attraction and repulsion characteristics which assist in producing and maintaining flake alignment and resist translational movement of the flakes. The alignment of the flakes along the magnetic flux lines coupled with their attraction and repulsion properties relative to each other when aligned provide the desired change in light transmission characteristics in the dispersion medium.

Another example of a permeable flake exhibiting the aspect ratio phenomenon which provides the desired alignment properties are magnetic fine cylindrical fibers. For example, when seven-micron diameter nickel-coated graphite fibers are cut to 50-micron lengths, these fibers have an aspect ratio of 50:7:7 and exhibit the desired alignment characteristics within the dispersion medium during exposure to a magnetic field.

In the exemplary embodiment, complete alignment of the flakes will occur when the flakes are exposed to the magnetic field, assuming that each of the flakes has the proper geometry or aspect ratio to align itself with the flux lines of the magnetic field. However, differences in the aspect ratios between individual flakes may produce an incomplete alignment of each flake in the system when a magnetic field is introduced thereto. The alignment effect, however, is most pronounced as the average aspect ratio increases within a given population of magnetic flakes.

A population of permeable flakes with an aspect ratio having at least two of the height, length or width measurements, for example, of approximately about 5:1 or greater, or, more specifically, approximately about 10:1 or greater is to overcome most effects of varying flake size. Permeable flakes having aspect ratios in these ranges have been observed to provide the desired change in light transmission in the dispersion medium during flake alignment. However, in the event irregularly-shaped flakes are used (which prevent true measurement of absolute length, width or height), the measurements used to calculate the aspect ratio correspond to the longest linear measurement along the geometry of the flake, the other aspect ratio measurements taken perpendicular thereto.

The relative strength of a magnetic field is often depicted not by the number or density of flux lines but may also be shown by the thickness of the flux lines. Notably, magnetic field strength varies both according to the relative strength of the magnetic field and to the configuration of the magnet or magnetic field source. Therefore, the strength of the magnet and density of the flux lines is an important factor to consider in inducing the flake alignment phenomenon of the visual display.

The relative strength of the magnetic field as reflected by the density of the flux lines is not here depicted. Rather, the strength may be selected somewhat empirically to effect the formation of an image.

Referring to the drawings, FIG. 1 shows a magnet 10. While a permanent magnet is preferred as the magnet 10, it is within contemplation that an electromagnet may be used with the electrical force being supplied from a suitable remote power supply by a wire or from a small battery within an associated stylus as hereinafter discussed. The magnet 10 of FIG. 1 is shown spaced at a distance 16A above a dispersion medium 12 within which a plurality of permeable flakes 14 are randomly dispersed. The permeable flakes 14 can be made of a ferromagnetic material, such as nickel, stainless steel, iron and various combinations of such materials. The flakes 14 here depicted are rectangular and quite large relative to their actual size

The dispersion medium 12 with the permeable flakes 14 is retained within a volume 15 defined by opposing surfaces 18 and 19. In one example, the surface 18 has or includes a transparent or translucent area which allows observation of the flake alignment phenomenon through and in the dispersion medium 12 as light 17 passes through surface 19 through a translucent or transparent section toward the surface 18 as will be discussed in detail below.

The magnet 10 is here shown to be cylindrical with an axis 11 oriented normal to the surface 18. While the magnet 10 is shown to be cylindrical, it may be in any suitable or desired shape. For purposes of this invention, the magnet 10 is preferably one in which the height or length 58 exceeds the diameter 59. Indeed, the preferred magnet 10 of the present invention will have a height or length 58 that is at least two times bigger than the diameter 59 and even more preferably at least five times the diameter 59. While there is no particular limit to the height or length 58, practical use would limit it to about one foot or there about.

An electro magnet or permanent magnet like magnet 10 are sometimes said to have a north pole and a south pole or alternately a positive pole 20 and a negative pole 22. The magnet 10 has a magnetic field 24 which is three-dimensional force field around its entire perimeter or circumference 13. The force field 24 is typical for permanent magnets with the field being stronger closer to the outer surface 15 and generally weaker the farther away 21 from the magnet 10 in any direction generally normal to the axis 21 or even along the axis 11. Of course the force field at the poles or positive end 20 and negative end 22 is also strong as is known for magnets having poles and more particularly for permanent magnets. The magnetic field 24 is here depicted in two dimensions by a plurality of flux lines 26 radiating or extending between the positive pole 20 and the negative pole 22. Given that the magnet 10 has a preselected magnetic strength, the magnet 10 may be placed at a distance 16 from the surface 18 that is selected so that the magnetic field 24 is so weak that it can be said to have no effect on the permeable flakes 14 dispersed in the medium 12.

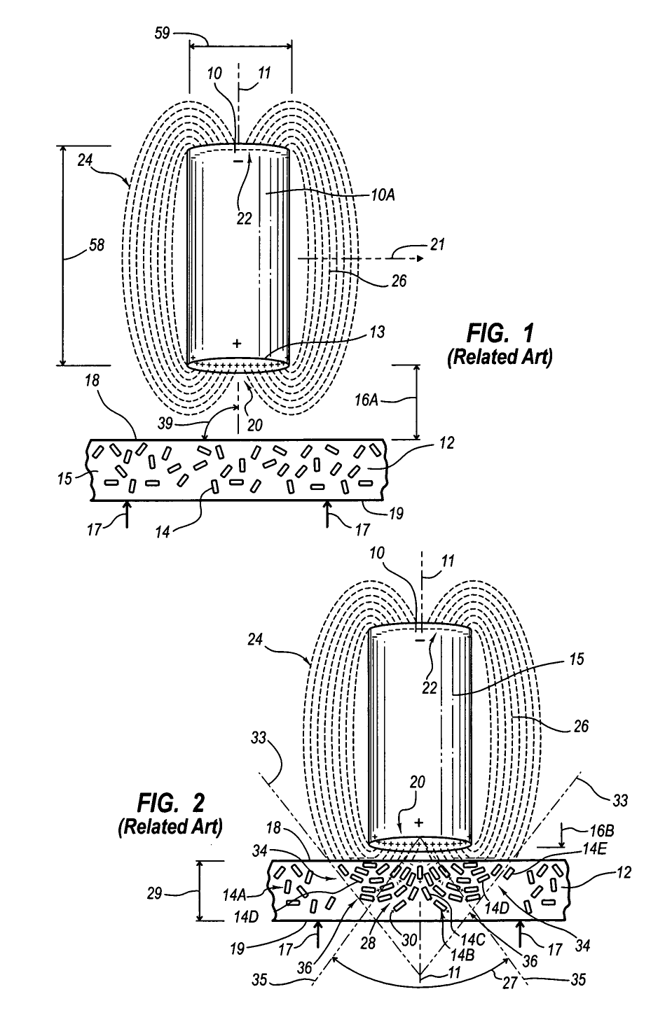

Referring to FIG. 2, the magnet 10 is shown being positioned at a distance 16B selected so that the magnetic field has sufficient strength to interact with the flakes 14 in the dispersion medium 12. The permeable flakes 14 A in random orientation dispersed in the medium 12 are thus now under the influence of the magnetic field 24 and thus the flakes 14B and more specifically 14C, D and E (by way of example) orient themselves along the flux lines 26.

As stated hereinbefore the flakes 14 are permeable so they become magnetic in the presence of the magnetic field 24 of the magnet 10. In turn, each flake 14 in the presence of the magnetic field has a north pole and a south pole or a positive pole and a negative pole as indicated by the plus (+) and minus (−) signs 30 respectively Since it is well known that for two proximately positioned magnets, magnetic opposites attract (e.g., north and south poles) and magnetic likes (e.g., north pole and north pole) repel. The induced magnetic field in each of the flakes 14 is believed to be positive to negative as shown. With the induced magnetic field, the permeable flakes 14B-E align so that their positive (+) and negative (−) poles are attracted to each other and to the positive or negative pole of the magnet 10.

In the alignment zone 28, it can be seen that the flakes 14B near the pole 20 or close to the axis 11 tend to be oriented somewhat normal to the surface 18 and in general alignment with the axis 11. That is, the magnetic field 24 is at or less than angle 27. In turn, the aligned flakes 14C are closer to alignment with axis 11. With the thickness 29 of the volume 15 selected so that the magnetic field 24 extends through surface 19, it can be seen that the flakes 14C closest to the axis 11 (within the angle 27) are oriented to allow light 17 to pass through surface 19, through the medium 12, past aligned flakes 14C and through surface 18 to be visible. At the same time, the flakes 14D aligned in the magnetic field in a direction somewhat normal to axis 11 block or inhibit the light transmission to help define the image visible at the surface 18. Of course, the flakes 14E begin to align vertically as the magnetic field or lines of flux get closer to being generally parallel to the axis 11. Some additional light 17 may pass through the medium and create a short of halo or shadow of the image along the axis 11 between the aligned flakes 14D and the randomly dispersed flakes 14A that are outside the influence of the magnetic field 24. In turn, the perceived resolution of the perceived image is reduced and seen mare as a line that is not sharp and distinct. Thus one seeking to present letters or numbers is forced to present larger letters or numbers than if the lines were very sharp or with a high resolution.

From another perspective, it may be said that the light 17 transmission characteristics of the dispersion medium 12 in the alignment zone 28 is greater than in zones 29 and 36 on either side of zone 28. The magnetic field 24 imposes a somewhat V-shaped 33 orientation of the flakes 14E in outer zone 34 providing a “halo” effect along the edges of the alignment zone 28. The induced halo results in less resolution (larger lines) produced by the magnet 10. Similarly a V shaped orientation 35 is imposed on the flakes spaced somewhat from the axis 11 again contributing to a wider line with less resolution. At or beyond the outer zone 34, the flakes 14A remain essentially uninfluenced by the magnetic field and remain normally dispersed. It should also be noted that the angle of orientation 39 of the magnet 10 relative to the surface 18 may vary from about zero degrees to 90 degrees. As the angle 39 decreases from 90 degrees, the axis 11 crosses or intersects the surface 18 at an angle thereby modifying the location of the zones 28, 29, 34 and 36. As the angle 39 changes from 90 degrees to about zero degrees, it is believed that the alignment zones vary so that the resolution of the line or image created diminishes.

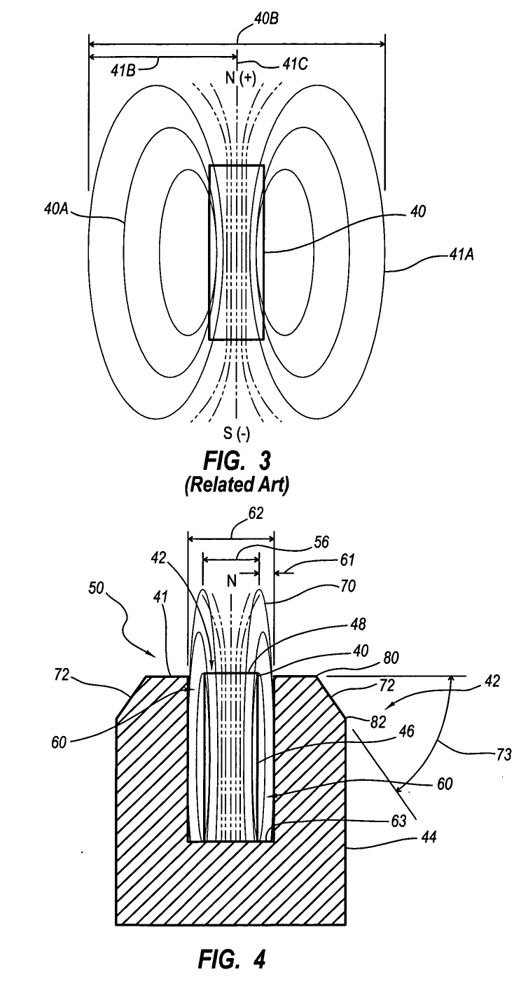

The alignment phenomenon, along with the number of influence zones of the permeable flakes 14, may vary depending upon the type and strength of magnet used as well as the geometry or shape of the magnet 10. FIG. 3 illustrates a typical cylindrical magnet such as magnet 40 with a magnetic field 40A illustrated by normal or unmodified flux lines 41A that radiate outwardly to a diameter of about 40. That is, the magnetic field 40A presents a magnetic force of sufficient magnitude or strength to influence some flakes 14 at a distance 41B from the axis 41C which is the axis of the magnetic field 40A.

Inasmuch as smaller magnets are not as strong as large magnets and have not been found to have sufficient magnetic force field to induce the permeable flakes 14 to align and produce a useful image, only larger magnets 10 have been used in systems of this type and in turn only images having larger lines with more discernable halo's can be formed.

When these writing devices are used in a tablet form, the amount of text or other markings are limited to the size of the tablet and the thickness of the lines drawn on it. Small tablets provide better portability and storability. For example, in a multiplication layout on the tablet, previously there was only room to fit 10×10 rows and columns. It is more desirable to have a 12×12 arrangement to allow teachers to teach pupils 1 to 12 times tables. This has been impractical based on the size of a typical tablet having a volume 15 with a medium (e.g. a viscous liquid-type material) due to the thickness of the lines created by the available stylus. In addition, handwriting was hard to practice with thick lines. Smaller magnets were used to make thinner lines, but lines were not as visible or distinct because the magnetic field is weaker and in turn the quantity of permeable flakes 14 aligned is less.

In FIG. 4, a small magnet like magnet 40 is positioned in and encased in a sheath 44 to yield a magnet with a magnetic field 70 shaped to create higher resolution images on the surface 18. The applicant was surprised to find that when the magnet 40 is encased in a ferromagnetic sleeve 44 or a sleeve containing a ferrous metal, the magnetic field 40A of the magnet was modified and concentrated to produce a magnetic field having a narrowed or modified diameter 62. When incorporated into a stylus, a higher resolution can be obtained.

FIG. 4 illustrates in cross section a tip 42 of a stylus or pen for use on or proximate s surface like surface 18. The tip 42 includes magnet 40 which is preferably a type “A” permanent magnet made from any suit able magnetic material. The magnet 40 is placed in a sleeve 44 which is made of a ferrous material. The magnet 40 can be press fit into, glued, held in place by a swaging (not shown) proximate the outer surface 41, held by a small set screw (not shown) or otherwise affixed to or in an aperture, recess or bore 60 formed in the sleeve 44. For example, an adhesive, such as Loctite brand adhesive manufactured by Henkel Loctite Corporation or Super Glue™, can be used to fix the magnet 40 in the sleeve 44.

The aperture or bore 60 is typically cylindrical in shape. The magnet 10 is typically formed to be cylindrical shape but it may also have facets or a plurality of sides to be triangular in cross section, elliptical in cross section, octagonal in cross section, or in some other suitable or desired cross section, all sized to snuggly receive the magnet 40. That is, the aperture 60 may be in any shape or combination of shapes sized to snuggly receive the magnet 10.

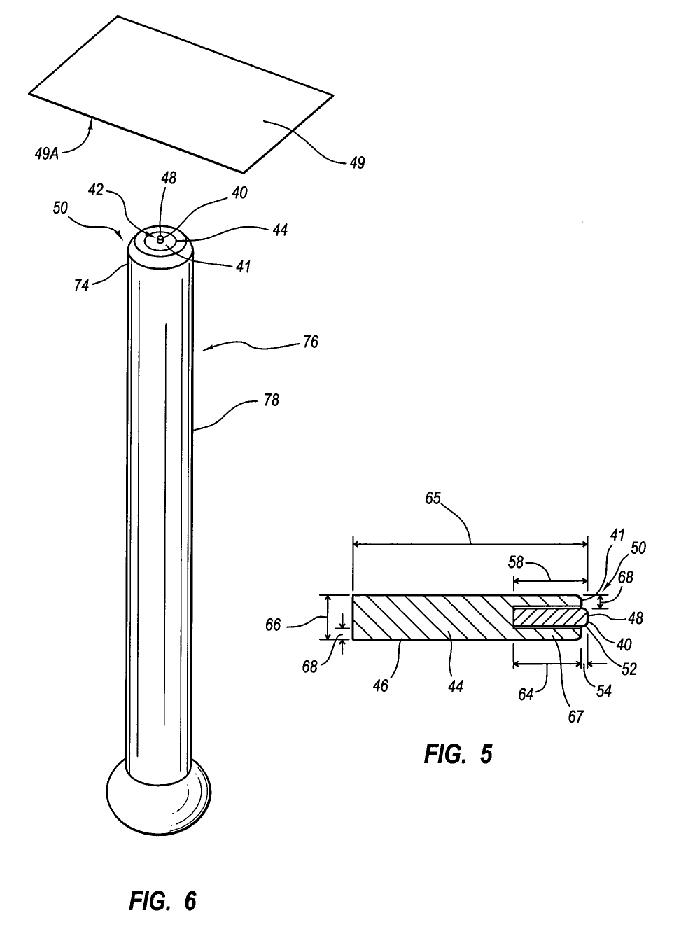

In FIGS. 5 and 6, a top or point 48 of the magnet 40 is located at a writing end 50 of a stylus 76. The point 48 extends beyond the sleeve 44 a distance 54 so that the point 48 can come into contact with the surface 18 with the sheath 44 held at an angle 39 less than 90 degrees (e.g., from about 70 degrees to about 40 degrees relative to the surface 19 of a writing pad 49 having a viscous material like material 12 with permeable flakes like flakes 14 mixed therein. The point 48 if cylindrical or ovular, has one edge 52 that is smooth to prevent damage to the surface 18 when writing and to facilitate ease of movement over the surface 18. The edge 52 can be a combination of beveled, tapered, rounded, or other similar shaped formed to eliminate sharp corners or edges that may wear or harm the writing surface 18.

In the various exemplary embodiments, the point 48 can extend beyond the sleeve 44 by various heights 54 depending on the application and desired line thickness. For instance, the point 48 can extend beyond the sleeve 44 by a height 54 (FIG. 5) of about 0.25 mm. In this example, the magnet 40 has a width or diameter 56 (FIG. 4) of about 0.8 mm and a length 58 of about 3.5 mm. The sleeve 44 has a bore 60 formed in it to receive the magnet 40 with a small gap or clearance 61 selected to hold an adhesive used to secure the magnet 40 in the bore 60. The bore 60 can have a width or diameter 62 of about 1 mm. In turn the clearance 61 is about 0.1 mm around the side 46 or outer surface of the magnet 10. The bore 60 has a depth 64 of about 3.2 mm to about 3.3 mm. The depth 64 of the bore 60 can be sized to provide the desired height 54 above the surface 41 of the sleeve 44. In this embodiment, the bore 60 has a depth 64 of about 3.2 to about 3.3 mm so that when the magnet 40 is inserted into the bore 60, the point 48 extends above the sleeve 44 about 0.25 mm plus such additional distance provided by glue or the like at or on the bottom surface 63 of the bore 60. While the bottom surface 63 of the bore 60 is here shown as a flat surface, it may be somewhat conical consistent with the shape of a drill head used to form the surface.

The bore 60 in the sleeve 44 forms a wall 67 that surrounds the magnet 40 and has a thickness 68 of about 0.5 mm. The sleeve 44 can be quite short (about 10 mm) in length 65 and sized to fit into another structure or housing to function as a pen, pencil or similar writing instrument. It may be sized in length 65 from about 5 centimeters to about 10 or more centimeters to accommodate a magnet 40 of suitable strength but which is in effect long and narrow.

As shown in FIG. 4, when the magnet 10 is placed in the sleeve 44, the magnetic field 70 is narrowed or modified by the sleeve to essentially match the width or diameter 62 of the aperture 60 of the sleeve 44. Thus the sleeve 44 focuses the magnetic flux of the magnet 40 and in turn makes the alignment zone 28 narrower than the alignment zone for the magnet 40 by itself or without a sleeve 44. The narrower alignment zone 28 means that the image visible to the user has higher resolution. That is, lines formed by magnet 40 in the sleeve 44 are sharper and narrower so the user may write smaller. The differences between the magnetic fields of the magnet 40 with and without the sleeve 44 are illustrated by the flux lines 41A of FIG. 3 in comparison to the flux lines 70 in FIG. 4.

The sleeve 44 is made of ferromagnetic material, such as iron. Of course other ferromagnetic compositions may also be used. While the material is not magnetic, is permeable. It is believed that the ferromagnetic material directs or limits the width 41B of the flux lines 41A to make the magnetic field projected into the dispersion medium 12 with flakes 14 of a gel pad or the like. The sleeve 44 can be seal coated to prevent or resist corrosion, for example, a ceramic based coating can be applied to the surface of the sleeve 44. The coating provides a smoother surface on the writing end 50.

The width 56 of the magnet 40 can vary depending on the desired size of the visual image and more particularly the lines being formed by movement of the tip 58 over the surface 18. For instance, one size can simulate a typical line formed by a ball-point pen or pencil; while another size (slightly larger) can be sized to simulate a line formed by a felt-tip marker. In yet other embodiments, the magnet 40 and sleeve 44 can be sized so that the line formed on the surface 18 simulates a piece of chalk. Some examples of the various embodiments are shown in Table A, below.

TABLE A

| Ex- | | | | | Mag- |
|---|---|---|---|---|---|
| am- | | | | | netic |
| ple | Magnet Size | | Length | Diameter | Flux |
| 1 | 2.5 × 10 | mm | 10 mm +/− 0.1 | 2.5 mm +/− 0.05 | 3,100 G |
| 2 | 1.4 × 6.5 | mm | 6.5 mm +/− 0.1 | 1.4 mm +/− 0.05 | 1,900 G |
| 3 | 1.0 × 5 | mm | 5 mm +/− 0.1 | 1.0 mm +/− 0.05 | 1,300 G |
| 4 | 0.8 × 3.5 | mm | 3.5 mm +/− 0.05 | 0.8 mm +/− 0.05 | 1,100 G |

The sleeve 44 is placed around the various magnets like magnet 40 to narrow the magnetic flux or field. Typically, the sleeve 44 which surrounds the magnet examples listed in Table A to form the tip 42 has a thickness of about 0.5 mm to about 1.5 mm. The sleeve 44 has a slanted surface 72 around the writing end 50 of the tip 42 that is positioned at an angle 73 relative to the tip surface 41 that varies from about 60 degrees to about 15 degrees with the edges 80 and 82 preferably rounded or tapered to provide a smooth feel as the tip 42 is moved across the surface 18. If the surface 72 is rounded to a radius, the radius can be approximately the same as the thickness 68 of the sleeve 44. For instance, if the thickness of the sleeve is about 0.6 mm, then the radius can be about 0.45 mm at the writing end 50. Of course the surface 72 may also be shaped into any desired arcuate (in cross section) form so that the tip may move more easily over the display surface.

The tip 42 can then be inserted into, formed in, or otherwise disposed in an end 72 of a pen or stylus 74 as illustrated in FIG. 5. The stylus 74 can include a housing or grip 76 to allow a user to hold the pen 74. The housing or grip 76 can be formed of any shape or size. For example, the grip 76 can be shaped to simulate a writing instrument, such as a pencil or pen having a long cylindrical structure, or like a figurine, or other structure that can be gripped by a user or mechanism to move the stylus 74. The grip 76 can be formed into cartoon characters, animals, plants and even vegetables to entertain small children or as novelty items. The tip 42 in the stylus is then operated to create lines or patterns in the dispersion medium 12 visible at surface 18 as hereinbefore discussed. It may also be noted that the stylus 72 may be configured to be positioned in a machine or other device to cause it to move along or over the display surface 18 to create a desired image.

The flux lines of the magnetic field 70 pass through the surface 18 of the dispersion medium 12, causing the permeable flakes 14 mixed within the dispersion medium 12 to orient themselves and align along the flux lines of the magnetic field 70, creating an image. The alignment of the permeable flakes causes an image to be created as a result of a change in the transmission of light through and into the dispersion medium 12. When the flux lines of the magnetic field 70 are introduced to the flakes 14 as depicted in FIG. 1, the flakes 14 align with the longitudinal axis of each of the flakes 14 becoming oriented such that they are, for example, generally aligned along and generally parallel to the flux lines of the magnetic field 70 which influences the area of the dispersion medium 12 in which the flakes 14 are dispersed. While lined up along the flux lines, the permeable flakes 14 change the light transmission characteristics of the dispersion medium 12, thus producing an image.

The magnetic field 70 of the magnet 40 acts upon the suspended permeable flakes 14 in an area adjacent the tip 42. Moving the tip 42 over the dispersion medium 12 causes the flakes 14 in an area adjacent to the surface 18 to be oriented from a random position to another position that is essentially vertical to or in alignment with the axis 41C of the magnet 40. To the observer, this re-orientation of flakes 14 produces an image and preferably a black image, in contrast to the metallic sheen observed on the remainder of the surface 18 because light does not transmit therethrough. Alternately, it should be understood that light may transmit through surface 18 through the dispersion medium 12 toward the surface 19 which has an interior color so that upon reflection of the light back out of and through the surface 18 so that the user perceives a desired color.

While the stylus and tip have been described with reference to the specific embodiments described, the descriptions are only illustrative and are not to be construed as limiting the invention. As such, the optimal dimensional relationships for the parts of the exemplary embodiment of the invention can be varied in size, materials, shape, configurations, form, function and manner of operation. The optimal dimensional relationships, use and assembly that are readily apparent to those skilled in the art and all equivalent relationships to the embodiments illustrated in the drawings and described in the specification are intended to be encompassed by the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A stylus for arranging a selected zone of permeable flakes in a dispersion medium within a volume having a display surface, the stylus comprising:
a housing having a first end and second end;
a magnet for positioning proximate one 6f said first end and said second end, said magnet having a magnetic field of a magnitude selected to influence permeable flakes in a first portion of said dispersion medium when positioned proximate said display surface; and
a sleeve attached to said housing at one of said first end and said second end, said sleeve being formed to receive the magnet, said sleeve being made of a ferromagnetic material and configured to direct the magnetic field to a second portion of the permeable flakes, said second portion being smaller than said first portion.

2. The stylus of claim 1, wherein the sleeve has a cylindrical bore and wherein the magnet is sized to fit snuggly in said bore.

3. The stylus of claim 1, wherein said housing is a grip sized for grasping by the hand of user; and wherein the magnet extends out from the sleeve a preselected distance for contact with said display surface.

4. The stylus of claim 1, wherein a said sleeve is covered with a protective coating.

5. The stylus of claim 1, wherein the magnet has a diameter of about 2.5 mm and has a length of about 10 mm.

6. The stylus of claim 1, wherein the magnet has a diameter of about 1.4 mm and has a length of about 6.5 mm.

7. The stylus of claim 1, wherein the magnet has a diameter of about 1.0 mm and has a length of about 5 mm.

8. The stylus of claim 1, wherein the magnet has a diameter of about 0.8 mm and has a length of about 3.5 mm.

9. The stylus of claim 1, wherein the sleeve has a thickness of about 0.5 mm to about 1.5 mm, the thickness of the sleeve surrounding the magnet.

10. The stylus of claim 3, wherein the sleeve includes an arcuate surface formed at the writing end of the tip.

11. The stylus of claim 10, wherein the corners are rounded to a radius that is approximately equal to the thickness of the sleeve.

12. The stylus of claim 11, wherein the thickness of the sleeve is about 0.6 mm and the radius is about 0.45 mm at the writing end.

13. The stylus of claim 3, wherein the grip is shaped to simulate a writing instrument.

14. The stylus of claim 3, wherein the grip has a figurine shape.

15. A stylus for arranging permeable flakes in a dispersion medium positioned within a volume having a display surface, said stylus comprising:
a housing for positioning proximate the surface of the volume containing magnetically permeable flakes suspended in a dispersion medium, said housing having a first end and a second end;
a sleeve attached to one of said first end and said second end of said housing, said sleeve having a recess sized to receive a magnet, said sleeve being formed of a ferromagnetic material and configured to direct the magnetic field of a magnet positioned within said recess; and
a magnet secured within said recess, said magnet having opposite poles, said magnet having a first end and a second end each end acting as one of said opposite poles, said magnet having a magnetic field with lines of flux, said magnet being of preselected strength to cause said permeable flakes to align along the lines of flux of the magnetic field.

16. The stylus of claim 15 wherein said recess is a cylindrical bore, and wherein said magnet is cylindrical and sized to be snuggly positioned within said bore to extend outward therefrom a distance for contacting said display surface.

17. A system for creating a visual image, said system comprising:
a volume having permeable flakes in a dispersion medium positioned within a volume having a display surface and a source of light for passing through said dispersion medium;
a stylus for positioning proximate said display surface to influence said permeable flakes from a random pattern inhibiting the passage of light through said dispersion medium to a pattern in which light may pass through said dispersion medium past a selected portion of said dispersion medium, said stylus comprising:
a housing for positioning proximate the display surface of said volume, said housing having a first end and a second end,
a sleeve attached to one of said first end and said second end of said housing, said sleeve having a recess sized to receive a magnet, said sleeve being formed of a ferromagnetic material and configured to direct the magnetic field of a magnet positioned within said recess, and
a magnet secured within said recess, said magnet having opposite poles, said magnet having a first end and a second end each end acting as one of said opposite poles, said magnet having a magnetic field with lines of flux, said magnet being of preselected strength to cause said permeable flakes to align along the lines of flux of the magnetic field.

18. A stylus for arranging permeable flakes in a dispersion medium, the stylus comprising:
a magnet having at least one side; and
a sleeve disposed around the side of the magnet, the sleeve being made of a ferromagnetic material and arranged to modify the magnetic flux of the magnet, at least a portion of the magnet extending out from the sleeve to interact with the permeable flakes.

19. The stylus of claim 18, wherein the magnet and sleeve have a cylindrical shape, the sleeve having a bore, and the magnet being inserted into the bore.

20. The stylus of claim 18, wherein the magnet and sleeve are attached to a grip to form a tip at a writing end of the grip.
